(19) United States
(12) Patent Application Publication
(10) Pub. No.: US 2026/0110826 A1
(43) Pub. Date: Apr. 23, 2026

(54) PLASMONIC NANOSTRUCTURE WITH EXCELLENT COLOR FIDELITY AND METHOD FOR FABRICATING THE SAME

(71) Applicant: Gwangju Institute of Science and Technology, Gwangju (KR)

(72) Inventors: Hyeon-Ho JEONG, Gwangju (KR); Jang-Hwan HAN, Gwangju (KR); Gyurin KIM, Gwangju (KR); Juhwan KIM, Gwangju (KR)

(21) Appl. No.: 19/289,438

(22) Filed: Aug. 4, 2025

(30) Foreign Application Priority Data
Oct. 17, 2024 (KR) 10-2024-0142426

(51) Int. Cl. G02B 5/00; B82Y 20/00; G02B 1/00; G02B 1/02

(52) U.S. Cl. CPC G02B 5/008; B82Y 20/00; G02B 1/002; G02B 1/02

(57) ABSTRACT

Embodiments relate to a plasmonic nanostructure with excellent color fidelity and a method for fabricating the nanostructure. According to one embodiment, by growing metal nanoparticles embedded within a dielectric matrix by a co-evaporation method, the scattering properties of the metal nanoparticles may be suppressed and the absorption properties thereof may be maintained, so that color purity may be controlled more precisely, and the colors in transmission mode and reflection mode may be tuned independently. Meanwhile, by using low-temperature process conditions, it is possible to selectively control the size, density, and degree of distribution of metal nanoparticles during deposition without performing an additional subsequent process.

### CROSS REFERENCE TO RELATED APPLICATION

This application claims the benefit of and priority to Korea Patent Application No. 10-2024-0142426, filed on Oct. 17, 2024, the entire contents of which are hereby incorporated herein by reference.

### BACKGROUND

### 1. Technical Field

The present disclosure relates to a plasmonic nanostructure with excellent color fidelity and a method for fabricating the nanostructure.

### 2. Related Art

An optical dichroic superstructure refers to a thin film or nanostructure having color dichroism due to optical dichroic properties, and may be used in various applications, including nano-sized pixels, filters, and resonators, depending on the principle of displaying color.

Specifically, the superstructure may be basically used as a dichroic filter or resonator. In addition, the superstructure may selectively display a transparent state and a colored state through transmission mode and reflection mode, and thus may be applied to information encryption technology that allows data to be invisible in transmission mode but to be visible only in reflection mode. In addition, since transparent conduction may be controlled to a certain extent and stacking is possible, the superstructure may be used in data storage devices or implementing multiple images according to the viewing angle.

Meanwhile, studies have recently been actively conducted to realize ultra-small pixels, projectors, lenses, etc. using flat optics based on plasmonics and metasurfaces. However, despite recent improvements in process technology, technological advancement has been limited to some extent due to problems such as high difficulty in the process required for metasurface fabrication, low yield, limitations in implementing vivid colors, thickness limitations of multilayer thin-film resonators, and the need for mirror structures.

Accordingly, there is a need for the development of a technology for fabricating a dichroic structure with excellent color fidelity and high reproducibility over a large area through an easier process. In particular, there is a need for new materials, process methods, or nanostructures that can overcome various problems, such as limited color diversity of existing plasmonic-based dichroic structures, angle-dependent deterioration of dichroic properties, or reduction in color clarity due to scattering wavelength shift caused by nanoparticles with non-uniform size.

### PRIOR ART DOCUMENTS

### Patent Documents

(Patent Document 1) KR 10-2020-0128178 A

### SUMMARY

An object of the present disclosure is to provide a plasmonic nanostructure with excellent color fidelity and a method for fabricating the nanostructure.

Another object of the present disclosure is to provide a plasmonic nanostructure which includes metal nanoparticles embedded within a dielectric matrix and grown by co-evaporation so that the scattering properties of the metal nanoparticles may be suppressed and the absorption properties thereof may be maintained so that color purity may be controlled more precisely.

Still another object of the present disclosure is to provide a plasmonic nanostructure which may exhibit excellent color fidelity in transmission mode based on combining a particular type of dielectric and a particular type of plasmonic metals, and may exhibit excellent color fidelity in reflection mode based on controlling the thickness thereof.

Yet another object of the present disclosure is to provide a method for fabricating a plasmonic nanostructure under low-temperature process conditions, which may selectively control the size, density, and degree of distribution of metal nanoparticles during deposition without an additional subsequent process.

To achieve the above objects, a plasmonic nanostructure according to one embodiment of the present disclosure includes: a dielectric matrix; and metal nanoparticles, wherein the metal nanoparticles are embedded within the dielectric matrix.

The dielectric matrix includes a dielectric selected from the group consisting of SiO₂, HfO₂, TiO₂, Al₂O₃, and mixtures thereof.

The metal nanoparticles include a metal selected from the group consisting of Ag, Au, Pt, Al, Cu, Cr, V, Mg, Ti, Sn, Pb, Pd, W, Te, Mo, Mn, and alloys thereof.

The plasmonic nanostructure may exhibit excellent color fidelity in transmission mode based on combining a particular type of dielectric matrix and a particular type of metal nanoparticles.

The plasmonic nanostructure may exhibit excellent color fidelity in reflection mode based on controlling the thickness thereof.

The plasmonic nanostructure may exhibit dichroic properties using localized surface plasmon resonance (LSPR) and thin-film interference.

The plasmonic nanostructure may be formed by co-deposition of the dielectric and the metal nanoparticles by e-beam evaporation and/or thermal evaporation.

The metal nanoparticles may have a diameter of less than 10 nm.

The metal nanoparticles may have a diameter of 2.5 to 9.5 nm.

The atomic ratio between the metal nanoparticles and the dielectric matrix included in the plasmonic nanostructure may be 10:90 to 80:20.

The plasmonic nanostructure may be a stacked structure in which two or more nanostructures having different types of metal nanoparticles and/or dielectrics are stacked.

A dichroic filter according to another embodiment of the present disclosure includes the plasmonic nanostructure.

A dichroic reflector according to still another embodiment of the present disclosure includes the plasmonic nanostructure.

An optical modulator according to yet another embodiment of the present disclosure includes the plasmonic nanostructure.

A method for fabricating a plasmonic nanostructure according to still yet another embodiment of the present disclosure includes steps of: 1) introducing a metal source and a dielectric source onto independent boats in a deposition chamber, respectively; and 2) applying voltage to each of the boats under a vacuum condition, and vaporizing the metal source and the dielectric source, thereby co-depositing the metal source and the dielectric source on a substrate in the deposition chamber

The atomic ratio between the metal source and the dielectric source introduced in step 1) may be 10:90 to 80:20.

The temperature of the substrate in step 2) may be 213K to 273K.

The present disclosure relates to a plasmonic nanostructure with excellent color fidelity and a method for fabricating the nanostructure. According to the present disclosure, by growing metal nanoparticles embedded within a dielectric matrix by a co-evaporation method, the scattering properties of the metal nanoparticles may be suppressed and the absorption properties thereof may be maintained, so that color purity may be controlled more precisely, and the colors in transmission mode and reflection mode may be tuned independently.

Meanwhile, by using low-temperature process conditions, it is possible to selectively control the size, density, and degree of distribution of metal nanoparticles during deposition without performing an additional subsequent process.

### BRIEF DESCRIPTION OF THE DRAWINGS

FIG. 1 relates to a plasmonic nanostructure according to one embodiment of the present disclosure. Specifically, FIG. 1a is a schematic view showing color-tunable transmission and reflection using plasmonic resonance and photonic resonance, respectively, and FIGS. 1b to 1d show the color tuning effect depending on the combination of the materials of a nanostructure in transmission mode, the absorption spectra of 5-nm nanoparticles, and the wavelength in the case of controlling the size of nanoparticles from 1 to 50 nm, respectively. Meanwhile, FIG. 1e shows the thickness variation of the nanostructure and an example of AuNP@SiO₂ (bottom panel) showing optical near-field enhancement, and FIG. 1f shows the absorption spectra versus the thickness. Meanwhile, FIG. 1g shows the absorption peak wavelengths depending on the thicknesses of various nanostructures, FIG. 1h shows the color tuning effect in reflection mode versus the thickness, and FIG. 1i shows associated dip wavelengths in reflection spectra of various nanostructures versus the thickness.

FIG. 2 relates to fabrication of a plasmonic nanostructure according to one embodiment of the present disclosure. Specifically, FIG. 2a is a schematic view showing a triple co-evaporation method of cooling a substrate to grow the nanostructure, FIG. 2b shows TEM images of multilayered nanostructures having different atomic ratios for each layer, FIG. 2c shows the results of associated false color elemental energy dispersive X-ray spectroscopy (EDX) mapping (Au: yellow, Si: cyan, O: pink), FIG. 2d shows the sizes of Au NPs averaged from over 70 (maximum 150) nanoparticles within each layer, and FIG. 2e shows four representative nanostructure layers having different sizes and densities of Au NPs.

FIG. 3 shows the results of examining the characteristics depending on the atomic ratio between the metal nanoparticles and the dielectric matrix of a plasmonic nanostructure according to one embodiment of the present disclosure.

FIG. 4 shows the effect of plasmonic nanostructures with stepwise thickness variation according to one embodiment of the present disclosure. Specifically, FIG. 4a is a schematic view showing 12 sections with different thicknesses, FIG. 4b shows six combinations of the dielectric and metal nanoparticles (sizes of nanoparticles in AuNP@SiO₂: 4.8±0.8 nm, AuNP@HfO₂: 4.5±0.5 nm, AuNP@TiO₂: 3.8±0.4 nm, CuNP@SiO₂: 5.1±1.1 nm, MgNP@SiO₂: 4.0±0.7 nm, and AgMgNP@SiO₂: 10.4±1.6 nm) included in the nanostructures, FIG. 4c shows the change in color of transmitted light with a change in the thickness, and FIG. 4d shows the change in color of reflected light with a change in the thickness.

FIG. 5 shows the results of conducting a comparative experiment on characteristics depending on the substrate temperature during co-deposition of metal nanoparticles and a dielectric according to one embodiment of the present disclosure.

FIG. 6 shows the results of examining the scattering and absorption spectral characteristics depending on the diameter of metal nanoparticles according to one embodiment of the present disclosure.

FIG. 7 shows bidirectional colorful dichroic engineering of plasmonic nanostructures according to one embodiment of the present disclosure. Specifically, FIGS. 7a and 7b show colors in transmission mode (left panel) and reflection mode (right panel) of MgNP@SiO₂ and AgMgNP@SiO₂, respectively, FIG. 7c shows primary color sets in transmission mode (left panel, R: AgMg@SiO₂, G: Cu@SiO₂, B: Au@HfO₂) while presenting thickness-sensitive coloration in reflection mode (right panel), and FIG. 7d shows associated CIE color plots.

FIG. 8 relates to steganography according to one embodiment of the present disclosure. Specifically, FIG. 8a shows a patterned Mg@SiO₂ single layer with switching between invisible transmission mode and colored reflection mode, FIG. 8b shows a 2-inch quartz wafer with various Mg@SiO₂ patterns, and FIG. 8c shows their optical images.

FIG. 9 shows colorful steganography according to one embodiment of the present disclosure. Specifically, FIG. 9a shows multi-patterned plasmonic nanostructures. Meanwhile, FIG. 9b shows a substrate with various nanocomposite patterns with three key features (i: color switching, ii: transparent steganography, iii to iv: colorful steganography), FIG. 9c shows associated optical interactions (top) and images (bottom), and FIG. 9d shows their optical spectra. FIG. 9e shows a QR code in reflection and a converted image with a black-and-white tone.

### DETAILED DESCRIPTION

Hereinafter, embodiments of the present disclosure will be described in detail so that those skilled in the art can easily carry out the present disclosure. However, the present disclosure may be embodied in various different forms and is not limited to the embodiments described herein.

As used herein, the term “room temperature (R.T.)” is defined as a range of 20 to 25° C.° C., more specifically 25° C.

Plasmonic nanoparticles may serve as non-fading pigments for vibrant outdoor glasses and smart windows, offering vivid colors under sunlight with exceptional spatial resolution. However, simultaneously achieving the desired plasmonic coloration in both reflection mode and transmission mode with a full-color gamut remains a formidable challenge, especially when using a single fabrication method.

In the present disclosure, dichroic color engineering was optimized through a physical triple co-deposition method to construct scalable plasmonic nanostructures. A key feature of such plasmonic nanostructures lies in extensive color performance in transmission and reflection modes, spanning from transparent invisibility to vivid full colors across the wavelength range of 200 nm to 950 nm. This excellent color fidelity may stem from their 3D-stacked nanostructure where plasmonic nanoparticles are embedded within a dielectric matrix with a uniform distribution. Meanwhile, wafer-scale rich and dynamic color images useful for colorful data storage and steganography may be generated through layer-by-layer color painting using a stacked structure in which two or more plasmonic nanostructures are combined and stacked.

The technology of utilizing plasmonics for structural coloration began with the discovery of the “Lycurgus cup”, which exhibits bidirectional, non-fading colors through metallic nano-pigments. This is still used to construct compact optical devices with excellent spatial resolution (<100 nm), particularly suitable for outdoor visualization.

Recent advances in nanofabrication and chemical synthesis further accelerates the exploration of diverse shapes and materials of plasmonic nanoparticles, enabling resonance tuning across the ultraviolet (UV) to near-infrared (NIR) range, thereby encompassing both visible and invisible colors. For example, Al and Mg nanostructures induce UV resonances (invisible light), whereas Au nanostructures enclosed within high-refractive-index materials achieve visible transparency due to the NIR resonance. Similarly, dispersion engineering through metal alloying, like Au—Ag, Au—Pd, and Ag—Pd, facilitates visible color tuning without altering the overall shapes and sizes. However, the inherent limitations of light extinction from single plasmonic nanostructures or monolayers cause low optical contrast, far from satisfying real industrial requirements.

To address this, studies have been conducted to enhance reflective colors by coupling a monolayer of plasmonic nanostructures with a thin film resonator, commonly referred to as an etalon. These plasmonic structures are meticulously patterned on a metal mirror containing a dielectric spacer. This configuration can selectively trap certain wavelengths of light within the spacer while reflecting the rest, thereby revealing distinct colors. Reducing the gap between the nanostructure and the mirror (<10 nm) may result in an extremely localized cavity resonance beneath the nanostructure, enabling uniform colors from disordered plasmonic arrays. While geometric and material engineering offer color tuning throughout the visible range, this mechanism relies primarily on reflection limited by the mirror. Utilizing ultra-thin mirrors (about 5 nm) is able to excite transmitted plasmonic colors through the mirror, but they are still in the early stage, lacking comprehensive color realization.

Thus, for plasmonic coloration in transmission, an alternative method has been extensively applied by mimicking the Lycurgus cup comprising multi-stacked plasmonic nanoparticles. Chemically synthesized plasmonic nanoparticles are encapsulated within continuous dielectrics or polymer shells and multi-layered on a substrate to form composite nanostructures. They show vivid colors as the thickness of the composite nanostructures increases, but this approach poses challenges in maintaining structural uniformity and color uniformity. Moreover, solution processes limit material selectivity due to the chemical instability of metallic nanoparticles in liquids.

Accordingly, the present disclosure provides a “solution-free” scalable fabrication method to construct plasmonic composite nanostructures using a triple co-evaporation method. Using a single growth step with two metals and a glass material may offer alloyed plasmonic nanoparticles containing various metals (Mg, Cu, Ag, and Au) within a dielectric matrix and provide precise control over their thickness and material stoichiometric ratios. Such “auto-protected” composite nanostructures with structural and material engineering according to the present disclosure enable non-fading bidirectional coloration through the entire visible range, spanning over 600 nm, from UV to NIR, while retaining individual sizes of the metal nanoparticles below 10 nm. The key feature of these tiny metal nanoparticles lies in silent scattering, yielding absorption-dominant transmission colors. This further simplifies spectral engineering in reflection mode by focusing solely on controlling the thickness of the composite nanostructure. As a result, in the present disclosure, layer-by-layer color painting was confirmed using combinatorial engineering in plasmonic nanostructures, and switchable images based on excited light direction were confirmed, which are potentially valuable for optical encryption and memory devices.

Hereinafter, the structural features of the plasmonic nanostructure to be provided in the present disclosure and the optical properties thereof, the specific applications of the plasmonic nanostructure, and the method for fabricating the plasmonic nanostructure will be described in detail.

A plasmonic nanostructure according to one embodiment of the present disclosure includes: a dielectric matrix; and metal nanoparticles, wherein the metal nanoparticles are embedded within the dielectric matrix.

The plasmonic nanostructure includes a structural feature in which a plurality of metal nanoparticles are uniformly embedded and distributed within a dielectric matrix. Thus, when the plasmonic nanostructure is illuminated with white light, the embedded metal nanoparticles may induce localized surface plasmon resonance (LSPR), thereby activating the plasmonic properties of the plasmonic nanostructure itself.

Meanwhile, through the above structural feature, it is possible to provide a dichroic thin film that may maintain a transparent state for transmitted light as needed and selectively display all colors in the visible range for reflected light based on controlling the thickness to a level of about 10 nm. More specifically, unlike existing color and wavelength selection technologies, “transmitted light color” may be realized by utilizing the optical absorption characteristics of the nanoparticles, and “reflected light color” may be realized by utilizing the thin-film effect, thereby improving the principle of realizing color and the resulting color fidelity.

The plasmonic nanostructure may be a stacked structure in which two or more nanostructures having different types of metal nanoparticles and/or dielectrics are stacked.

Specifically, the plasmonic nanostructure may be formed as a nanostructure in a stacked form by stacking each nanostructure. In this case, by configuring the types of dielectric and metal nanoparticles and/or the type of dielectric of the nanostructure forming each stacked structure differently, the desired optical selectivity may be realized for each layer.

The dielectric matrix includes a dielectric selected from the group consisting of SiO₂, HfO₂, TiO₂, Al₂O₃, and mixtures thereof. However, the materials that may be applied as the dielectric matrix of the present disclosure are not limited to the above examples.

Meanwhile, the metal nanoparticles include a metal selected from the group consisting of Ag, Au, Pt, Al, Cu, Cr, V, Mg, Ti, Sn, Pb, Pd, W, Te, Mo, Mn, and alloys thereof.

However, the metal nanoparticles are not limited to the above examples, and are defined as including all metal materials capable of exhibiting plasmonic properties, which may be applied as metal nanoparticles for the nanostructure of the present disclosure by those skilled in the art.

The plasmonic nanostructure may exhibit excellent color fidelity in transmission mode based on the combination of a particular type of dielectric matrix and a particular type of metal nanoparticles.

Meanwhile, the plasmonic nanostructure may exhibit excellent color fidelity in reflection mode as a result of controlling the thickness.

The present disclosure is characterized in that the color in transmission mode may be tuned by controlling a specific combination (material composition) of materials included in the nanostructure, and the color in reflection mode may be tuned by controlling the thickness of the nanostructure itself.

That is, the present disclosure is characterized in that, in order to overcome the disadvantage of the existing technology in which the degree of freedom in color selection is low because the color in reflection mode is automatically determined as the color in transmission mode is determined as a specific color, or because the color in transmission mode is automatically determined as the color in reflection mode is determined as a specific color, the color in transmission mode is fixed to a single color and the color in reflection mode is tuned through the thickness of the film, thereby separating the principles of realizing the colors in transmission mode and reflection mode.

Accordingly, according to the present disclosure, it is possible to independently design the color in reflection mode and the color in transmission mode by individually controlling the thickness and material composition of the nanostructure itself.

More specifically, in transmission mode, it is possible to realize a change in saturation change based on a specific single color through the combination of materials during co-deposition, and in reflection mode, it is possible to realize colors over the entire visible range that are mainly affected by the thickness change of the nanostructure itself regardless of the combination of materials. Furthermore, it is possible to selectively realize transparent nanostructures that are transparent to the human eye in one mode by utilizing materials such as Mg whose nanoparticle resonance wavelength is in the ultraviolet range, or by utilizing a dielectric matrix such as TiO₂ that can shift the resonance wavelength of Au to the infrared range.

The plasmonic nanostructure is formed by co-deposition of the dielectric and the metal nanoparticles by e-beam evaporation and/or thermal evaporation.

That is, the plasmonic nanostructure may be formed by co-deposition of the dielectric and the metal nanoparticles by using both e-beam evaporation and thermal evaporation, or by using one method selected from among e-beam evaporation and thermal evaporation.

As an example, the metal nanoparticles may be co-deposited by thermal evaporation and the dielectric matrix may be co-deposited by e-beam evaporation. Alternatively, both the metal nanoparticles and the dielectric matrix may be co-deposited by thermal evaporation, or both the metal nanoparticles and the dielectric matrix may be co-deposited by e-beam evaporation.

Specifically, the plasmonic nanostructure of the present disclosure is characterized by being able to exhibit dichroic properties using localized surface plasmon resonance (LSPR) and thin-film interference.

The localized surface plasmon resonance is an optical resonance that occurs when plasmonic nanoparticles interact with light, and may realize selective colors by causing reflection, transmission, and scattering for specific wavelengths of light. At this time, when the material or shape of the metal nanoparticles or the refractive index of the surrounding medium of the metal nanoparticles is changed, modulation of the resonance wavelength (color change) is possible.

Meanwhile, the thin-film interference phenomenon refers to the principle that, when light is incident on materials with different refractive indices, the lights reflected from the surface and bottom cause mutual interference, thereby allowing colors to be realized according to the refractive index and thickness of the thin film. However, in order to realize vivid colors, existing technologies mostly require thick film cavities or use multiple layers, which results in high process difficulty and increased overall thickness. In the case of existing studies focused on changing the color of reflected light using such nanostructures, there is a problem in that, since mirror surfaces are often added to nanostructures to increase color fidelity or saturation, it is generally difficult to apply the stacking-based integration technology.

Accordingly, the present disclosure is characterized by using a method of co-depositing the dielectric and the metal nanoparticles by thermal evaporation so that the above-described properties may be independently utilized in transmission mode and reflection mode. Thereby, it is possible to fabricate a nanostructure that exhibits color by absorption while minimizing the influence of scattering properties, by embedding and growing nanoparticles based on plasmonic materials such as Mg and Al to a desired size of less than 10 nm within a dielectric matrix.

Meanwhile, some deposition process methods that embed and grow metal or dielectric nanoparticles within a specific matrix have been reported. However, in the case of existing technologies, there is a problem in that the size and density of nanoparticles embedded and grown within the matrix is not uniform, or there is the inconvenience of having to perform an additional subsequent process to control the size of the nanoparticles.

Accordingly, the present disclosure is characterized in that it is possible to control the size of nanoparticles during deposition without a subsequent process or selectively achieve the density or degree of distribution of nanoparticles, by performing a method of co-depositing the dielectric and the metal nanoparticles by thermal evaporation and/or e-beam evaporation under low-temperature conditions.

The plasmonic nanostructure of the present disclosure is characterized in that the diameter of the metal nanoparticles embedded within the dielectric matrix is uniformly controlled to less than 10 nm, and in this case, color realization and color purity may be more precisely controlled by maintaining only the absorption properties while minimizing scattering generated by the plasmonic metal nanoparticles.

That is, the present disclosure is different from existing dichroic film structures in that the optical principle in transmission mode occurs by absorption rather than scattering, and as a result, is characterized in that, for transmitted light, even if the thickness of the nanostructure itself is increased, there is a change in the color tone, but the color itself may not be significantly changed.

Preferably, the diameter of the metal nanoparticles is less than 10 nm.

When the diameter of the metal nanoparticle is less than 10 nm, the absorption properties may be maintained while minimizing the scattering properties. Thereby, the color realization and color purity desired by the present disclosure may be precisely controlled, and furthermore, the colors in transmission mode and reflection modes may be independently tuned.

On the other hand, if the diameter of the metal nanoparticle is more than 10 nm, there is a problem in that the scattering properties are not reduced and are maintained, making it impossible to precisely control color realization and color purity.

Meanwhile, more preferably, the diameter range of the metal nanoparticles may be 2.5 nm to 9.5 nm, specifically 3 to 9.5 nm. In the above range, the desired effect may be maximized.

The atomic ratio between the metal nanoparticles and the dielectric matrix included in the plasmonic nanostructure is 10:90 to 80:20, specifically 10:90 to 70:30, more specifically 10:90 to 60:40.

When the atomic ratio between the metal nanoparticles and the dielectric matrix of the plasmonic nanostructure is within the above range, excellent dichroic properties using localized surface plasmon resonance (LSPR) and thin film interference may be realized, and as a result, the color realization and color fidelity desired by the present disclosure may be improved.

On the other hand, if the atomic ratio is lower than the lower limit of the above range, the metal nanoparticles may be included in an excessively small amount, so that the plasmonic properties may not be exhibited, and if the atomic ratio is higher than the upper limit of the above range, the metal nanoparticles occupy the majority of the nanostructure, so that only reflection properties may be exhibited without transmission properties, and thus the dichroic properties and independent color tuning effects in transmission mode and reflection mode desired by the present disclosure may not be exhibited.

A dichroic filter according to another embodiment of the present disclosure includes the plasmonic nanostructure.

A dichroic reflector according to still another embodiment of the present disclosure includes the plasmonic nanostructure.

A reflector is commonly referred to as a thin-film resonator. The thin-film resonator is a nanophotonic device that may display various colors by a very small thin-film thickness change at the nanometer level. Specifically, the thin-film resonator may be fabricated by coating a metal mirror layer with a thin film at the nanometer level, and may display various colors by changing the wavelength-dependent reflectivity of the sample. At this time, it may display various colors by changing the thickness of the coated thin film.

The reflector or thin film resonator according to one embodiment of the present disclosure is characterized in that it may display various colors in transmission mode and reflection mode by applying the plasmonic nanostructure of the present disclosure to the structure of the thin-film resonator.

That is, the thin-film resonator including the nanostructure of the present disclosure may exhibit the effect of changing color to various colors by changing the thickness of the nanostructure.

An optical modulator according to yet another embodiment of the present disclosure includes the plasmonic nanostructure.

Meanwhile, the optical modulator is an active optical element, and is not limited in the type and range thereof as long as it may be applied by a person skilled in the art to various optical devices requiring switching of an optical modulation function, such as an optical recording/reproduction system and a display device.

A method for fabricating a plasmonic nanostructure according to still yet another embodiment of the present disclosure includes steps of: 1) introducing a metal source and a dielectric source, respectively; and 2) vaporizing the metal source and the dielectric source, thereby co-depositing the metal source and the dielectric source on a substrate.

Specifically, the fabrication method may include introducing a metal source and a dielectric source onto independent boats in a deposition chamber, respectively, applying voltage to each of the boats under a vacuum condition, and vaporizing the metal source and the dielectric source, thereby co-depositing the metal source and the dielectric source on a substrate in the deposition chamber.

Meanwhile, process conditions such as a pressure condition and a voltage condition in the above co-deposition process vary depending on the types of metal source and dielectric source, and are not particularly limited as long as they are within the range of conditions that may be applied by a person skilled in the art to a thermal evaporation method and/or an e-beam evaporation method.

Preferably, the atomic ratio between the metal source and the dielectric source introduced in step 1) is 10:90 to 80:20, specifically 10:90 to 70:30, more specifically 10:90 to 60:40.

When the atomic ratio between the metal source and the dielectric source is within the above range, excellent dichroic properties using localized surface plasmon resonance (LSPR) and thin-film interference may be realized, and as a result, the color realization and color fidelity desired by the present disclosure may be improved.

Meanwhile, the temperature of the substrate in step 2) is 213K to 273K.

The present disclosure is characterized in that the plasmonic nanostructure is formed by co-deposition of metal nanoparticles and a dielectric by a thermal evaporation method. At this time, when co-deposition is performed at a temperature within the above temperature range of the substrate, the metal nanoparticles may be deposited on the dielectric with a uniform size, thereby exhibiting excellent color fidelity.

On the other hand, if the temperature of the substrate is lower than the lower limit of the above range, there may be a problem in that the degree of dispersion of the deposited metal nanoparticles increases, so that the size of each metal nanoparticle becomes excessively small, and thus the plasmonic effect cannot be exerted, and if the temperature of the substrate is higher than the upper limit of the above range, there may be a problem in that the uniformity of the size of the deposited metal nanoparticles decreases, and thus color reproducibility decreases.

### Experimental Preparation and Experimental Methods

### Numerical Simulation

The finite element method using commercial software (COMSOL wave optics module) was used to simulate the optical response of the plasmonic metal nanoparticles within the dielectric matrix. The perfectly matched layer was formed on both sides. The optical properties of Au, Mg, SiO₂, TiO₂, and HfO₂ were obtained from the known literature.

Meanwhile, the optical properties of the plasmonic nanostructures were simulated using the finite-difference time-domain (FDTD) calculation software (Lumerical Solution). The nanoparticles were embedded within the dielectric matrix with a volume range of 50% and distributed randomly. Then, the thickness was varied in the range of 10 to 100 nm at intervals of 10 nm, and the enhancement, absorption and reflection properties in the related optical near-field were examined.

### Growth of Plasmonic Nanostructures

2-inch Si wafer and quartz substrate were used as supporting substrates to grow plasmonic nanostructures.

Specifically, one or two metal materials as guest nanoparticles, including Au, Ag, Cu, Mg, AuMg, and AgMg, and dielectric host matrices, including SiO₂, TiO₂, and HfO₂, were co-evaporated in a single vacuum chamber under a base pressure of about 3×10⁻⁵ Torr. The long axis of the substrate holder was kept orthogonal to the vapor flux while constantly cooling at −35° C. (237K) during the growth process.

The alloying ratio of metal nanoparticles and their density in the dielectric matrix were tuned by controlling the deposition rate of each material, which was tracked by three different quartz crystal microbalance (QCM) monitoring systems.

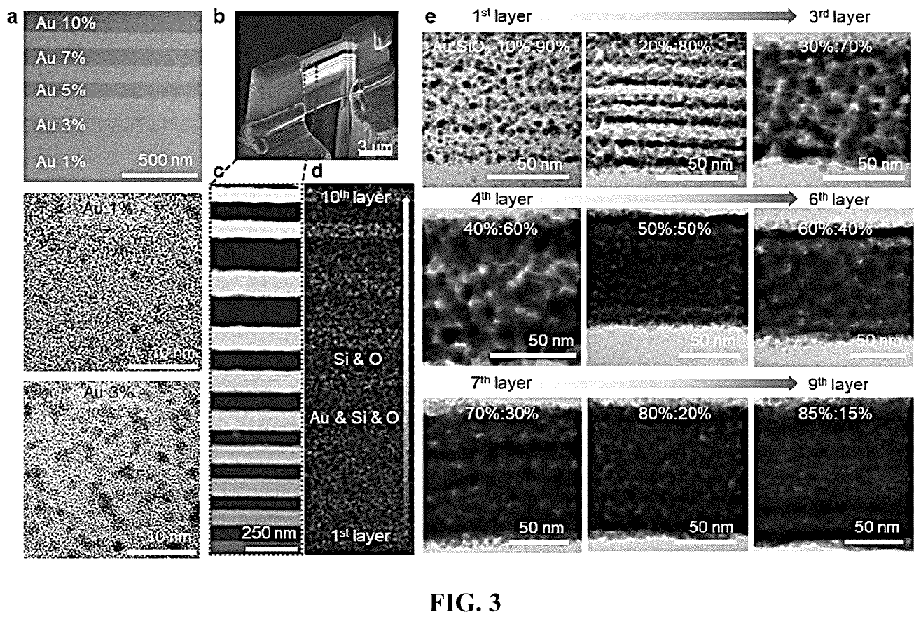

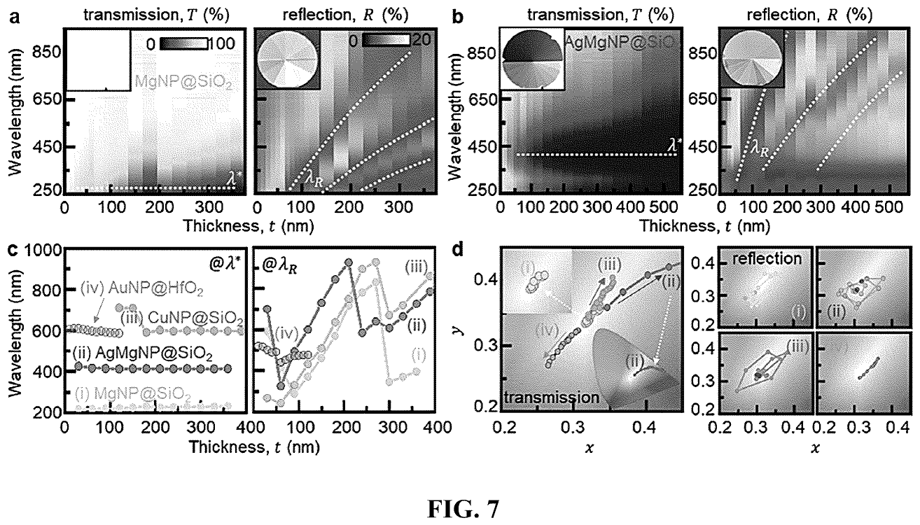

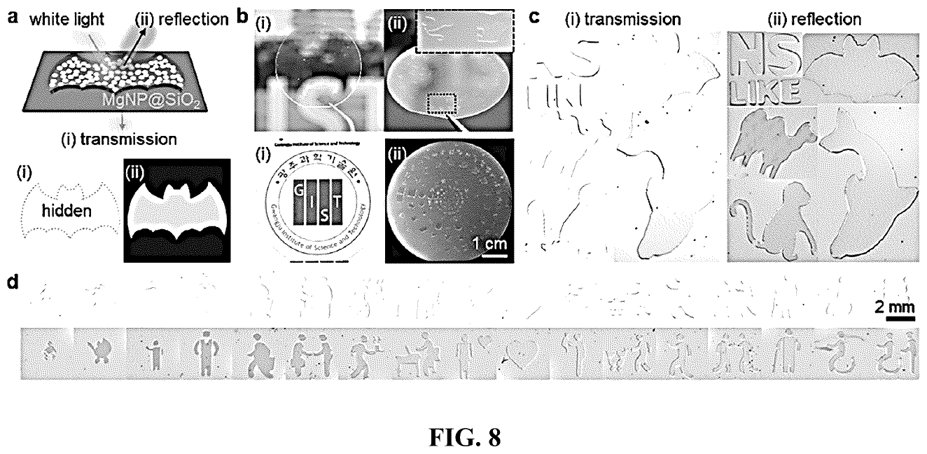

Various thicknesses of plasmonic nanostructures on the single sample were achieved using a half-blocking shadow mask. For example, the Au@SiO₂ sample in FIG. 3 was rotated at 30° intervals while growing by 10 nm thickness each to a total thickness of 60 nm over 180° rotation. Then, 70 nm thick structures were sequentially deposited to achieve a thickness variation of 10 to 120 nm at 100 nm thickness intervals within a single wafer. For structural patterning (e.g., FIG. 7), a 2-inch Al shadow mask fabricated using electroplating (INEXJK.CO., Korea) was inserted in front of the sample to selectively block the vapor flux, and “layer-by-layer” patterning (e.g. FIG. 8) was also conducted through multiple Al shadow masks, aligned with align key patterns.

### SEM and TEM Analysis

The thickness of the structure samples was measured by imaging the cross-sections at an accelerating voltage of 10 kV using a Hitachi S4700 scanning electron microscope (SEM) system. Meanwhile, TEM images were measured at an accelerating voltage of 300 kV using a FEI Tecnai G2 F30 S-Twin transmission electron microscope (TEM) system. To this end, the plasmonic structures were grown directly on the TEM grid (EMS CF400-CU, UL).

### Optical Characterization

Transmitted and reflected color images of fabricated structure samples were taken with a CMOS camera (STC-MCS500U3V, Sentech) through a 20× objective lens (Olympus MPLFLN-BD) in an inverted optical microscope (Olympus GX53). All photographic images of the plasmonic nanostructures grown on each 2-inch quartz substrate were taken with a SONY ILCE-6400 camera in a photo box under white LED illumination (color temperature of 5500K). A fiber-optic spectrometer (QE Pro spectrometer, Ocean Optics) was used with a DH-mini deuterium halogen light source to measure transmission and reflection in the range of 197 to 992 nm. An aluminum mirror (Edmund optics) was used as a reference.

### Experimental Results

### Color Tuning Effect in Transmission Mode and Reflection Mode (1)

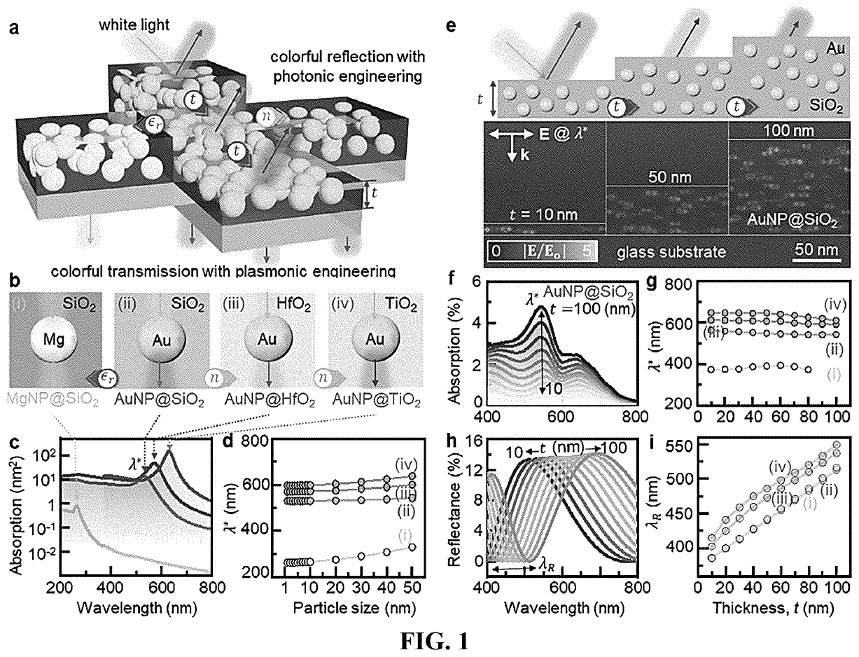

FIG. 1a is a schematic view showing the configuration of the plasmonic nanostructure of the present disclosure, which is composed of metal nanoparticles embedded within a thin glass film (dielectric matrix) on a quartz substrate. When illuminated with white light, the plasmonic nanostructure is plasmonically activated as individual metal nanoparticles within the dielectric induce localized surface plasmon resonance (LSPR). This resonance occurs when the total extinction, which is the sum of absorption and scattering, reaches a maximum, and is defined by Equation 1 below.

$${ε}_{r} ( {λ}^{*} ) = - χ {n}^{2} \qquad [ Equation 1 ]$$

wherein the LSPR wavelength λ* depends on the shape χ of the metal nanoparticle, the effective dielectric function εr (which represents the material composition), and the refractive index n of the surrounding medium (FIG. 1b).

From the perspective of spherical metal nanoparticles, the variation of χ effectively controls the peak intensities of absorption and scattering, but hardly changes the wavelength positions of the peaks (FIG. 1c). For example, Au nanoparticles embedded in a SiO₂ matrix with a diameter of more than 70 nm exhibit scattering at λ*=570 nm, which is dominant over absorption. However, it was confirmed that, as the size of the Au nanoparticles decreased below 40 nm, the scattering became less prominent than absorption, causing a bit of blue shift in the associated peak wavelength (λ*=548 nm for 40 nm Au nanoparticles). In particular, it was confirmed that further reducing the nanoparticle size below 10 nm offered nearly “scattering-free” plasmonic resonance, where the colors predominantly originate from absorption at λ*=530 nm regardless of its size variation (FIG. 1d).

This distinctive property of the plasmonic nanostructures rules out the effects of both the scattering and the shape factor χ on coloration. Consequently, material composition engineering of εᵣ for metal nanoparticles and n for dielectric matrix in Equation 1 above functions as effective means to modulate color space (FIG. 1b).

Meanwhile, numerical simulations suggest that, for instance, while maintaining the size of the metal nanoparticles at 5 nm and their surrounding dielectric matrix (SiO₂), changing the material of the nanoparticles from Au to Mg (i.e., εᵣ engineering from AuNP@SiO₂ to MgNP@SiO₂) solely enables the LSPR peak shift from λ*=530 nm to 262 nm (FIG. 1c).

Furthermore, referring to FIG. 1d, it was confirmed that the n engineering, i.e., changing the dielectric matrix from SiO₂ to HfO₂ (or TiO₂) while embedding the same sized Au NP inside exhibited the red shift in the plasmonic color from λ*=530 nm (at AuNP@SiO₂) to 571 nm (at AuNP@HfO₂) (or 598 nm at AuNP@TiO₂), due to the difference in their intrinsic indices of refraction, regardless of the light wavelength characteristics of nSiO₂<nHfO₂<nTiO₂.

Consequently, it can be seen that it is possible to design the transmission color space of the plasmonic nanostructure across the UV to NIR region using the absorption-dominant LSPR colors through combinatorial material engineering.

Another characteristic of this “scattering-free” plasmonic coloration is that the reflection color of the plasmonic nanostructure follows the principles of photonic thin-film reflection, which arises from interference between the upper and lower interfaces of the nanostructures (FIG. 1e).

Therefore, adjusting the thickness of the film or structure can ensure absorption-dominant colors in transmission by tuning the reflection color while maintaining the size of the nanoparticles to less than 10 nm (FIGS. 1f to 1g). For example, AuNP@SiO₂ plasmonic nanostructures with various thicknesses t from 10 to 100 nm at 10 nm intervals are modeled, where multiple 5 nm AuNPs are embedded within the SiO₂ matrix at an atomic ratio of 50:50% (volume fraction of 31%) (FIG. 1e). Simulation results for these plasmonic nanostructures show that small changes in the structure thickness still play in designing reflection colors over the entire visible range from λ_{R}=385 to 514 nm (the dip wavelength, FIG. 1h) while keeping the plasmonic absorption unchanged at λ*=546 nm (FIG. 1f). It can be confirmed that this feature is still valid for all types of material-engineered composite plasmonic nanostructures, especially MgNP@SiO₂, AuNP@HfO₂, and AuNP@TiO₂ used for the transmission color design (FIG. 1i).

These unique properties of the plasmonic nanostructures allow for independent design of colors in reflection and transmission modes by controlling the geometric thickness and material composition, respectively, which is experimentally verified in the following experiments.

### Color Tuning Effect in Transmission Mode and Reflection Mode (2)

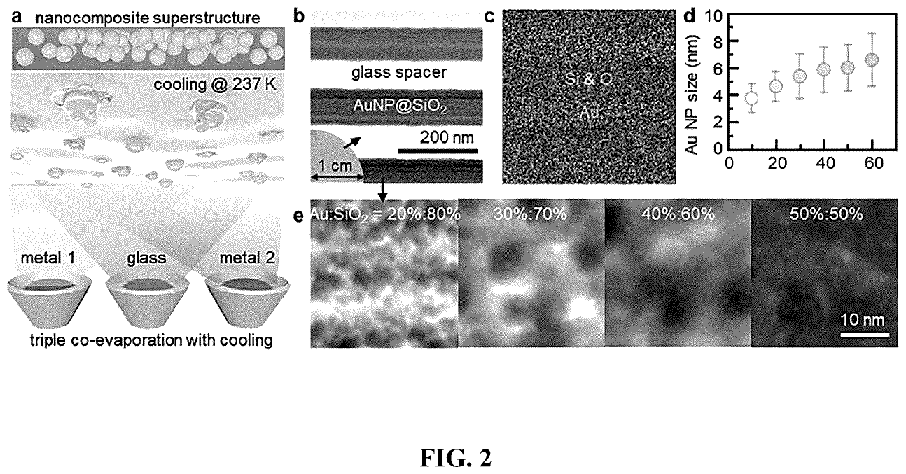

To precisely control the material composition of the plasmonic nanostructure, a triple co-evaporation technique with substrate cooling was used (FIG. 2). One or two metals are co-evaporated as alloyed nanoparticles along with a host dielectric material. Since metals and glass (dielectric) are typically immiscible, co-deposition of these dissimilar atomic bonding materials triggers phase separation, thereby forming metal nanoparticles within the dielectric matrix (FIG. 2a). This is because the thermodynamic mobility of metallic adatoms and their strong atomic attraction cause them to cluster immediately upon landing on the surface to form nanoparticles. Furthermore, the continuous introduction of an immiscible oxide as a physical barrier prevents the further coalescence of metal nanoparticles, enabling their stacking within the dielectric matrix with precise thickness control (FIG. 2b).

Meanwhile, while similar fabrication methods using sputtering and evaporation techniques have been used, a unique feature of the fabrication method of the present disclosure is that it incorporates the first triple-material co-evaporation, which can significantly expand the material library of nanostructures. In addition, it is characterized by being able to dissipate the thermal energy of metal atoms and minimize diffusion by cooling the substrate to 237K. It is characterized in that, since this temperature belongs to zone 1 of the structural zone model, anisotropic growth occurs, and nanoparticles with a uniform size of less than 10 nm may be formed regardless of the type of metal material.

To demonstrate how to manipulate materials and geometry within the plasmonic nanostructure, i.e., AuNP@SiO₂, the inventors of the present disclosure fabricated AuNP@SiO₂ using co-evaporation of Au and SiO₂, which are a plasmonic metal and a dielectric material (FIG. 2c).

While growing 11 layers of 100 nm thick nanostructures, the present inventors meticulously controlled their material composition with the ratio of gold (Au) and silica (SiO₂) ranging from 10%:90% to 95%:5% and increased the ratio of Au by 10% each to reach 80%, and then increased the ratio of Au by 5% each. Sections were evenly spaced with the bare SiO₂ film to clearly distinguish between different conditions and, uniquely, they were all grown in a single growth step, which is impossible to achieve using any other currently known method.

It can be confirmed that transmission electron microscopy (TEM) images of the cross-sections of each plasmonic nanostructure show AuNPs within the SiO2 matrix, and show various sizes and densities (FIG. 2d). As the Au ratio increases, the average diameter of AuNPs gradually increases from 4±1 nm to 6±1.8 nm, and uniformly increases at 1 nm intervals for every 10% increase from 20% to 50% Au (FIG. 2d). Meanwhile, it is uniformly formed throughout the wafer (FIG. 2e). At the same time, the volume density of AuNPs increases correspondingly from 10% to 31%. Precise control of the size and density of AuNPs within the SiO2 matrix can manipulate the color intensity while having little effect on tuning the plasmonic color, thereby providing additional engineering space. However, in order to mainly highlight how to efficiently explore the entire visible color space in both transmission and reflection modes using a minimum of variables (thickness for reflection and material composition for transmission), the atomic ratio between the metal nanoparticles and the matrix for all the plasmonic nanostructures used for coloration in the present disclosure was fixed to 50%:50%.

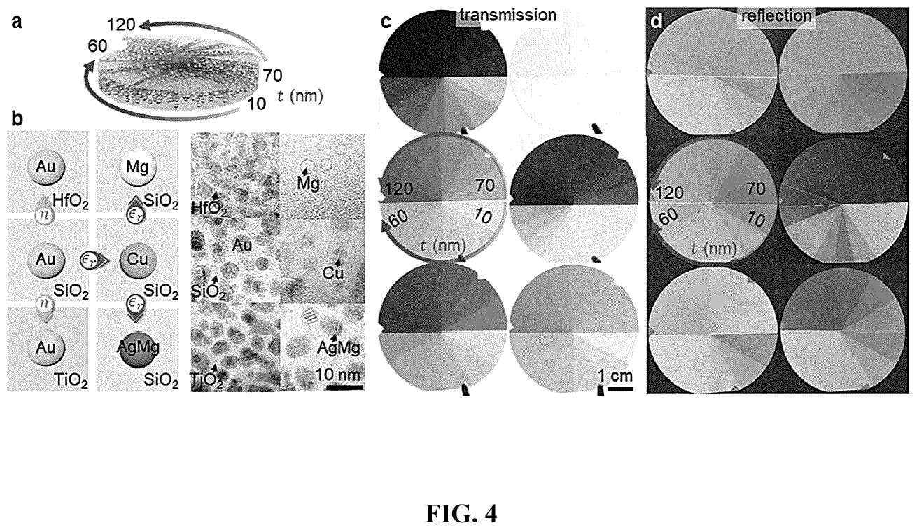

To effectively visualize and directly compare the colors of various plasmonic nanostructures, wafer-scale nanostructures comprising 12 sections with thicknesses (t) ranging from 10 to 120 nm and spacing of 10 nm were grown (FIG. 4a). These sections can intuitively visualize color uniformity as well as t-sensitive changes in reflection or transmission in the same optical environment. For example, the AuNP@SiO₂ plasmonic nanostructure with AuNPs of about 6 nm (50% Au atomic ratio, FIG. 4b) displayed distinct consistent red brown color in transmission mode despite the thickness variation (FIG. 4c). Meanwhile, in reflection mode, varying thicknesses within the same atomic ratio exhibit the t-sensitive reflective colors across the entire visible spectrum (FIG. 4d). Furthermore, co-depositing SiO₂ with either Mg or Cu in a 50%:50% atomic ratio results in distinct transmission colors, dictated by the plasmonic absorption characteristics of the respective εᵣ engineering nanoparticles, as shown in FIG. 1. It can be confirmed that, regardless of thickness, the CuNP@SiO₂ plasmonic nanostructures containing Cu NPs of about 5.1 nm consistently exhibit a distinct green hue in transmission mode, whereas the MgNP@SiO₂ formed with Mg NPs of about 4.0 nm shows no coloration due to UV resonance (FIG. 4c). On the other hand, it can be confirmed that both cases exhibit sensitive reflection colors according to the thickness change in reflection mode (FIG. 4d). In addition, when the dielectric material is changed from SiO₂ to HfO₂ or TiO₂ (i.e., n-engineering), the color of AuNP@HfO₂ in transmission mode changes to a blue hue, and that of AuNP@TiO₂ changes to a green hue, which is because red-shifts occur in the plasmonic absorption peak wavelengths due to the high refractive indices of HfO₂ and TiO₂. That is, it can be seen that t-sensitive full-color reflection still remains achievable for these samples.

Thus, it is possible to experimentally confirm that the transmission colors in the plasmonic nanostructures are tunable with εᵣ and n engineering, while full-coloration in reflection is possible with t-engineering, achieved through the whole nanostructures.

### Confirmation of Characteristics According to Control of Atomic Ratio Between Metal Nanoparticles and Dielectric Matrix

The structural characteristics according to the range of the atomic ratio between the metal nanoparticles and the dielectric matrix included in the plasmonic nanostructure of the present disclosure were confirmed, and the results are shown in FIG. 3.

Specifically, referring to FIG. 3e, it can be confirmed that, when the atomic ratio between the metal nanoparticles and the dielectric matrix is 10:90 to 80:20, the metal nanoparticles are uniformly embedded within the dielectric matrix. In particular, it can be confirmed that the metal nanoparticles are more uniformly embedded when the atomic ratio is in the range of 10:90 to 70:30, more specifically 10:90 to 60:40. However, it was confirmed that when the atomic ratio was out of the above range, an excessively small number or excessively large number of the metal nanoparticles were distributed, resulting in poor uniformity.

Accordingly, it can be seen that, when the atomic ratio between the metal nanoparticles and the dielectric matrix is within the above range, the uniformity of the particle distribution is excellent, so that excellent dichroic properties using localized surface plasmon resonance and thin-film interference may be realized.

Furthermore, referring to FIG. 2d, when the atomic ratio between the metal nanoparticles and the dielectric matrix is adjusted within the range of 10:90 to 60:40 and co-deposition thereof is performed, the diameter of the metal nanoparticles in the fabricated plasmonic nanostructure may be in the range of 3 to 7 nm.

That is, when the metal source and the dielectric source are co-deposited at an atomic ratio within the above range, the diameter of the metal nanoparticles may be maintained within a certain range, thereby precisely controlling the color realization and color purity desired by the present disclosure, and furthermore, independently controlling the colors in transmission mode and reflection mode.

### Confirmation of Characteristics Depending on Substrate Temperature During Co-Deposition of Metal Nanoparticles and Dielectric

In order to confirm the characteristics depending on the substrate temperature during co-deposition of the metal nanoparticles and the dielectric in relation to the method for fabricating a plasmonic nanostructure according to the present disclosure, Au and SiO₂ were used as the metal source and the dielectric source, respectively, and the plasmonic nanostructure was fabricated using the same method as the above-described method for growth of the plasmonic nanostructure, but with the substrate temperatures being different at 237K and room temperature (RT), respectively.

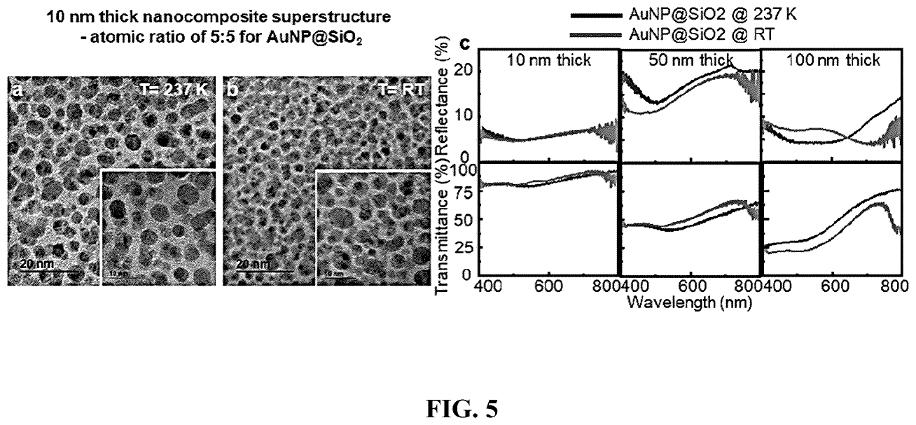

Referring to FIGS. 5a and 5b, which show the results of analyzing the structures of the two types of plasmonic nanostructures, it can be confirmed that, when co-deposition was performed under the RT condition, metal nanoparticles with various sizes were formed, and thus uniform metal nanoparticles were not formed, whereas when the co-deposition was performed under the 237K condition, uniform metal nanoparticles were formed.

Meanwhile, referring to FIG. 5c, it was confirmed that the deviation of the transmission and reflection spectra gradually increased as the thickness of the structure increased, when co-deposition was performed under the RT condition compared to when co-deposition was performed under the 237K condition.

### Confirmation of Scattering and Absorption Spectral Characteristics Depending on Diameter of Metal Nanoparticles

The optical properties depending on the difference in the diameter of the metal nanoparticles included in the plasmonic nanostructure of the present disclosure were examined based on scattering and absorption spectra.

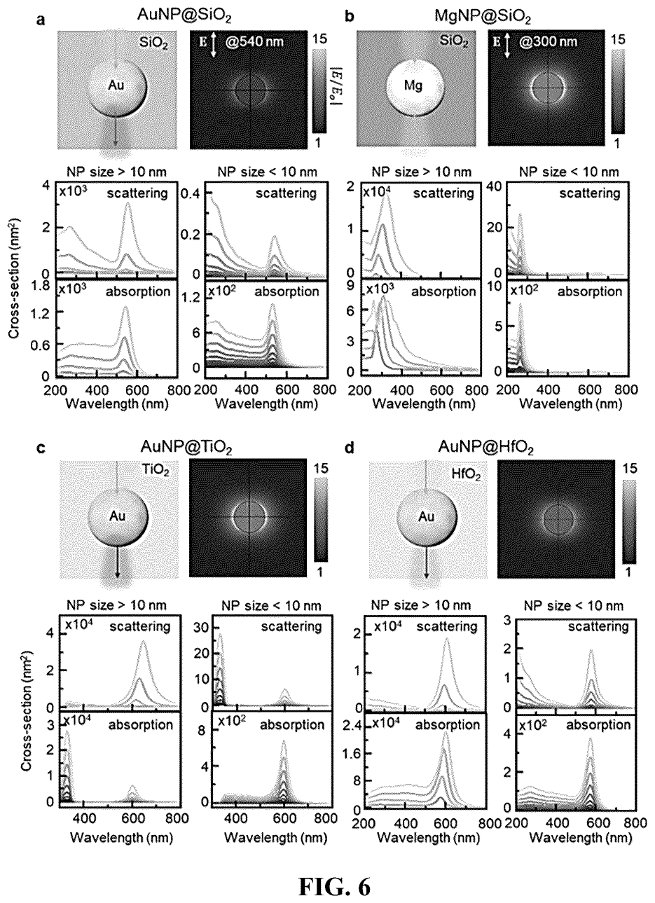

Referring to FIG. 6, it was confirmed that, when the diameter of the metal nanoparticles was more than 10 nm, both the scattering properties and the absorption properties were maintained, whereas when the diameter of the metal nanoparticles was less than 10 nm, the scattering characteristics could be minimized while the absorption properties could be maintained. Accordingly, it can be seen that, when the diameter of the metal nanoparticles is less than 10 nm, the color realization and color purity may be controlled more precisely, thereby each independently controlling the colors in transmission mode and reflection mode.

### Multicolor Engineering Via Plasmonic Nanostructures

Considering that each material composition and structural thickness of the plasmonic nanostructures play a critical role in the dichroic color, the present disclosure presents a thickness-sensitive overall color interaction in reflection mode, while more specifically identifying the material engineering space to precisely create primary color sets (RGB) as well as UV invisible features in transmission mode (FIG. 7).

Specifically, a remarkable transition from transparent and invisible to full colors was observed by switching between transmission and reflection modes (FIG. 7a). For the MgNP@SiO₂ plasmonic nanostructure, the presence of a single plasmonic peak wavelength was confirmed at about λ*=225 nm, indicating that increasing the thickness up to 360 nm facilitates a transmittance of about 90% or more in the entire visible light range (left panel of FIG. 7a). This spectral feature can be approximated by the absorption spectrum of the nanostructure due to small scattering effects, as confirmed in the simulation. Conversely, when observed in reflection mode, the peak wavelength λ_{R} was confirmed to show a noticeable redshift due to the influence of thin-film interference as the thickness (t) increases (right panel of FIG. 7a). This redshift occurs widely from the UV to the NIR region, shifting λ_{R} from 286 nm to 831 nm as the t increases from 30 nm to 360 nm (FIG. 7c). Importantly, although the first band eventually moves beyond the visible range when t exceeds 210 nm, thanks to the interference fringe, the second band gradually transits into the visible spectrum, which repeats continuously as the thickness increases.

One of the major advantages of triple co-evaporation is that it facilitates εᵣ engineering by precisely controlling the material composition of metal nanoparticles within a dielectric matrix. To verify this feature, Ag—Mg alloy nanoparticles were introduced into a SiO₂ matrix whose plasmonic color can be precisely tuned (FIG. 7b).

These colors range from invisible colors (associated with pure Mg NPs) at λ*=225 nm to visible colors (associated with Ag NPs) depending on the alloying ratio. AgMgNPs@SiO₂ nanostructures composed of Ag—Mg nanoparticles of about 10 nm formed at an atomic ratio of 50%:50% were grown. The nanostructures are formed in a single wafer with 18 sections of t-controlled layer, ranging from 30 nm to 540 nm with every 30 nm increment (inset of FIG. 7b). In transmission mode, the color of these nanostructures appears at around λ*=413 nm (left panel of FIG. 7b).

This central resonance peak remains while increasing the film or structure thickness (left panel of FIG. 7c), but progresses toward near the extreme red of the CIE coordinates at t=540 nm (FIG. 7d). Conversely, the reflection mode displays color variation across the whole visible spectrum, spanning from λ_{R}=324 nm to 944 nm, as the thickness of the plasmonic nanostructure increases (right panel of FIG. 7b). In particular, it was confirmed that red appeared at t=90 nm, blue at t=150 nm, and green at t=180 nm (right panel of FIG. 7c). The color was repeated in a cycle of about 120 nm thickness in reflection mode due to the interference phenomenon. For example, it was confirmed that red color appeared at t=90, 210, and 330 nm. These photonic properties have also been clearly demonstrated in other plasmonic nanostructures that generate various transmission colors.

These include the green of Cu@SiO₂ (or Au@TiO₂) and the blue of Au@HfO₂ (left panel of FIG. 7c), both of which exhibited thickness-sensitive reflection colors across the entire visible range. For example, λ_{R} in Cu@SiO₂ is found to span from 240 to 930 nm (right panels of FIG. 4 and FIG. 7c). Additional εᵣ engineering can create rich colors in transmission mode, such as the amber brown color of AuAg@SiO₂ and the light lemon color of AuMg@SiO₂.

As a result, it was confirmed that comprehensive colors can be obtained in both reflection and transmission modes by changing the thickness and material composition of the plasmonic nanostructure.

### Bidirectional Colorful Painting and Steganography Experiment

Plasmonic coloration can find applications in various photonic devices, ranging from intuitive non-fading colorful pictures to advanced sensing and imaging systems. Among various potential applications, the plasmonic nanostructures can be applied to optical memory and encryption devices with the advantage of the “layer-by-layer painting” concept, potentially expanding the storage capacity, currently stored in 2D.

In particular, the layer-by-layer painting concept can significantly enhance the efficacy of optical steganography. Optical steganography is a method for concealing optical information or an image within another optical image, wherein the hidden image becomes visible only under specific condition. In the present disclosure, two types of steganography methods using plasmonic nanostructures were demonstrated.

An example is the hidden images in transmission mode, fabricated through a shadow mask while growing 330 nm thick Mg@SiO₂ nanostructure (FIG. 8a). This nanostructure gives rise to UV plasmonic resonance, thus maintaining visible transparency over 90%. This means that the patterns comprising Mg@SiO₂ nanostructure are indistinguishable from their surrounding dielectric under sunlight and white light, and appear in a vivid purple color when reflected (FIGS. 8c and 8d).

This transition from invisible to visible color occurs across the entire 2-inch dielectric (with the potential flexibility of the supporting substrate) and matches with one obtained through the stepwise growth sample in FIG. 7a, suggesting that such transparent steganography may find applications in a variety of fields, including smart windows, energy harvesters, augmented reality (AR) vision systems, and electric vehicles.

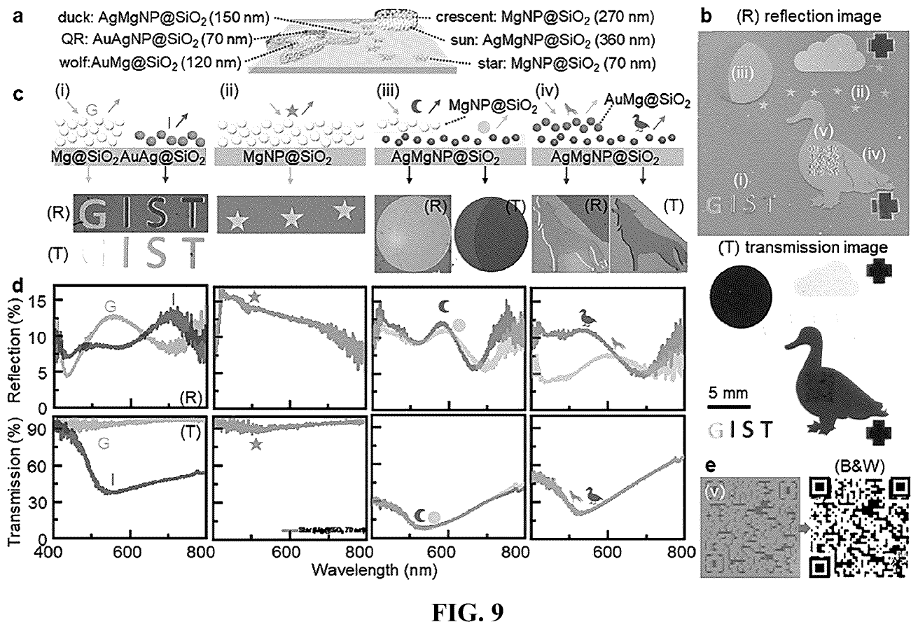

Meanwhile, according to the method for fabricating a plasmonic nanostructure according to the present disclosure, it is possible to grow a nanostructure having a multilayer structure layer-by-layer, and thus a plurality of nanostructures (up to 6 different stacked structures) may be stacked to create bidirectional colorful images including two types of steganographic patterns, thereby improving the dichroic image of the transparent single-layer structure (FIG. 9a).

The first feature is color shift from the mode switching between transmission and reflection modes, which can color change (FIG. 9b(i)). Meanwhile, the letter “G” comprises 300 nm Mg@SiO₂ for color transition from faint yellow to green, while the other letters “IST” comprise 80 nm AuAg@SiO2 for color transition from ginger to Egyptian blue (FIG. 9c(i)).

Secondly, it was confirmed that the transparent steganography from the Mg@SiO₂ nanostructure is still functional within the multilayered nanostructures (FIG. 9b(ii)). By depositing the 70 nm thick Mg@SiO₂ nanostructure on the Big Dipper constellation pattern, a transparent steganographic design can be obtained that is invisible under sunlight (visible light transmittance of about 90%) but clearly visible against a dark background (λ_{R}=559 nm) (FIG. 9c(ii)). Extending this concept further, it is possible to design multilayer nanostructures with different combinations of materials having similar transmission colors, thereby providing a way to hide specific patterns within an existing color image.

The first example shows the red-brown circular sun pattern in transmission that reveals the red crescent moon in reflection (FIG. 9b(iii)). The section of the crescent moon is made of 270 nm Mg@SiO₂ for the color transition, spanning from λ*=542 nm (in transmission mode) to λ_{R}=668 nm (in reflection mode), while the rest is fabricated with 360 nm AgMg@SiO₂ to show almost identical transmission color (λ*=542 nm) but different reflection color (λ_{R}=695 nm) (FIG. 9c(iii)).

As another example, the large duck pattern is dark orange in transmission (λ*=535 nm) and changes into two different colors, yellow (λ_{R}=462 nm) and green (λ_{R}=687 nm), so the hidden wolf image appears inside the body of the duck pattern in reflection (FIGS. 9b to 9d(iv)). In other words, discrepancy arises from the different material combinations of the plasmonic nanostructures, where the duck pattern includes 150 nm AgMg@SiO₂, while the wolf pattern adds 120 nm AuMg@SiO₂. Another representative example of optical information encryption and encoding through steganography is a 120 nm thick AuMg@SiO₂ layer deposited in the configuration of a QR code pattern atop a duck pattern (FIG. 9e). In transmission mode, the QR code shows a dark brown color (λ*=525 nm) which is similar to the duck pattern beneath, making it challenging to discern the QR code pattern clearly due to its dull and unclear shape. However, in reflection mode (λ_{R}=574 nm), the QR code transforms into a different color of dark purple, enabling distinct recognition of the pattern. To enhance readability with a conventional QR code reader, light image processing can be applied to alter the line color to black, facilitating the decoding of stored information within the secured QR code.

Accordingly, the nanostructure of the present disclosure is characterized in that it can enhance the performance of various types of optical devices, such as anti-counterfeiting, data storage, image multiplexing, and steganography, through the “layer-by-layer” approach, and has the advantage of being able to ensure very high chemical, thermal, and mechanical stabilities, thanks to the nature of the rigid dielectric matrix.

The present disclosure provides a plasmonic nanostructure comprising metal nanoparticles embedded within a dielectric matrix, which is dual-programmable for transmission and reflection colors across the entire visible spectrum (from the UV to NIR region).

Furthermore, unlike conventional fabrication methods typically used for plasmonic structures such as 2D, the present disclosure utilizes triple co-evaporation with substrate cooling to control the material composition and structural thickness of metal nanoparticles and dielectric matrix, thereby enabling the growth of 3D-scalable plasmonic nanostructures with a high level of engineering flexibility. In addition, the method for fabricating a nanostructure according to the present disclosure can ensure high flexibility in the form of the substrate with large scalability from nano and micro patterns to the entire wafer. As a result, the present disclosure realizes diverse transparent and colorful steganographic images, achieved through the combinatorial stacking of various plasmonic nanostructures, and thus may be applied to various photonic memory and encryption devices.

Although the preferred embodiments of the present disclosure have been described in detail above, the scope of the present disclosure is not limited thereto, and various modifications and improvements made by those skilled in the art using the basic concept of the present disclosure defined in the following claims also fall within the scope of the present disclosure.

What is claimed is:

1. A plasmonic nanostructure, comprising:
a dielectric matrix; and
metal nanoparticles,
wherein the metal nanoparticles are embedded within the dielectric matrix.

2. The plasmonic nanostructure according to claim 1, wherein the dielectric matrix comprises a dielectric selected from the group consisting of SiO₂, HfO₂, TiO₂, Al₂O₃, and mixtures thereof.

3. The plasmonic nanostructure according to claim 1, wherein the metal nanoparticles comprise a metal selected from the group consisting of Ag, Au, Pt, Al, Cu, Cr, V, Mg, Ti, Sn, Pb, Pd, W, Te, Mo, Mn, and alloys thereof.

4. The plasmonic nanostructure according to claim 1, wherein the plasmonic nanostructure exhibits excellent color fidelity in transmission mode based on combining a particular type of dielectric matrix and a particular type of metal nanoparticles.

5. The plasmonic nanostructure according to claim 1, wherein the plasmonic nanostructure exhibits excellent color fidelity in reflection mode based on controlling a thickness thereof.

6. The plasmonic nanostructure according to claim 1, wherein the plasmonic nanostructure exhibits dichroic properties using localized surface plasmon resonance (LSPR) and thin-film interference.

7. The plasmonic nanostructure according to claim 1, wherein the plasmonic nanostructure is formed by co-deposition of the dielectric and the metal nanoparticles by e-beam evaporation and/or thermal evaporation.

8. The plasmonic nanostructure according to claim 1, wherein the metal nanoparticles have a diameter of less than 10 nm.

9. The plasmonic nanostructure according to claim 1, wherein the metal nanoparticles have a diameter of 2.5 to 9.5 nm.

10. The plasmonic nanostructure according to claim 1, wherein an atomic ratio between the metal nanoparticles and the dielectric matrix comprised in the plasmonic nanostructure is 10:90 to 80:20.

11. The plasmonic nanostructure according to claim 1, wherein the plasmonic nanostructure is a stack structure in which two or more nanostructures having different types of metal nanoparticles and/or dielectrics are stacked.

12. A dichroic reflector comprising the plasmonic nanostructure according to claim 1.

13. A method for fabricating a plasmonic nanostructure, comprising steps of:
1) separately introducing a metal source and a dielectric source; and
2) vaporizing the metal source and the dielectric source, thereby co-depositing the metal source and the dielectric source on a substrate.

14. The method according to claim 13, wherein an atomic ratio between the metal source and the dielectric source introduced in step 1) is 10:90 to 80:20.

15. The method according to claim 13, wherein a temperature of the substrate in step 2) is 213K to 273K.
